(19) United States
(12) Patent Application Publication
(10) Pub. No.: US 2010/0242926 A1
(43) Pub. Date: Sep. 30, 2010

(54) FUEL HEATING APPARATUS

(76) Inventor: Christopher John Biddulph, Staffordshire (GB)

Correspondence Address: OPTICUS IP LAW, PLLC, 7791 ALISTER MACKENZIE DRIVE, SARASOTA, FL, 34240, US

(21) Appl. No.: 12/734,343

(22) PCT Filed: Oct. 24, 2008
(86) PCT No.: PCT/GB2008/050987

§ 371 Date: Apr. 26, 2010

(30) Foreign Application Priority Data
Oct. 27, 2007 (GB) 0721149.3

(51) Int. Cl. F02M 31/12; F02M 31/125; F02M 31/13

(52) U.S. Cl. 123/549; 123/557; 123/556

(57) ABSTRACT

A fuel heating apparatus for an internal combustion engine or other type of spark ignition engine having an associated pressurised fuel delivery system, the apparatus comprising a chamber for receiving a volume of a pressurised liquid fuel; and means for heating the fuel within the chamber to provide heated liquid fuel to the fuel delivery system of the engine, to thereby minimise condensation of the fuel and facilitate ignition of the engine within relatively low ambient temperature environments. The apparatus has particular application with ‘heavy fuels’, such as diesel or kerosene, and improves the reliability and performance of the engine especially during ‘cold starts’ and while transitioning to fast-idling.

The present invention relates to internal combustion engines and fuel delivery systems, and in particular relates to a fuel heating apparatus for a spark-ignition engine.

Internal combustion engines are commonly used in many applications, including automotive, marine, aviation and power generation systems. The two main types of engine generally fall into two broad categories, known as ‘spark-ignition’ and ‘compression-ignition’ engines. The first type of engine operates by igniting a fuel-air mixture by way of a spark (e.g. from a sparkplug), while the second type relies on heat from the compression of the air to ignite the fuel-air mixture. Spark-ignition engines conventionally run on petrol (otherwise known as gasoline), while compression-ignition engines normally make use of relatively heavier fuels, such as diesel or kerosene.

Due to environmental concerns and cost issues, there has been an ever increasing trend to use other types of fuel with spark-ignition engines to improve efficiency, reduce operating costs and lower polluting emissions. Therefore, it is not uncommon to run particular types of spark-ignition engine on fuels such as autogas (LPG), methanol, ethanol, compressed natural gas (CNG), hydrogen and even nitromethane. However, there is now an increasing desirability to use ‘heavy fuels’ to run spark-ignition engines, particularly within military and aviation applications, so as to reduce operating costs, increase engine efficiency and reduce logistical supply problems. A drawback of this is however that there are particular technical difficulties associated with the use of heavy fuels, particularly when an engine is to be operated within environments where there is a relatively low ambient temperature, as occurs during cold weather or at altitude, for example, in the case of aviation engines or in mountainous regions.

It is to be appreciated herein that by ‘heavy fuels’ we mean all hydrocarbon fuels that have a higher viscosity than petrol (gasoline), and in particular include paraffin, diesel and kerosene etc.

It is known that there are inherent difficulties in using heavy fuels in internal combustion engines, as for example, diesel is prone to “waxing” or “gelling” in cold weather. This waxing causes the fuel to partially solidify into a crystalline state that can build up in the fuel filters and eventually starve the engine of fuel. Low-output electric heaters in the fuel tank may be used to minimise this effect and to lower the viscosity of the fuel to thereby improve engine reliability. However, in particularly low ambient temperature environments, the heavy fuel can undergo condensation on the surfaces of critical components of the fuel delivery system, such as the throttle body and/or fuel manifold, due to the cold engine block extracting heat from the fuel. This effect can therefore lead to problems with ignition of the engine (i.e. during start-up) and/or transitioning to engine idling (during warm-up) and may result in subsequent engine cut-out, thereby significantly reducing the engine's reliability.

The present invention therefore seeks to overcome, or mitigate against, the above effects of using heavy fuels in spark-ignition engines, by providing an improved fuel heating apparatus that can facilitate engine ignition and promote a more stable transition to fast-idling of the engine. In this way, the present invention aims to increase engine reliability and efficiency, by minimising the effects of fuel condensation, particularly in applications where the engine is to be operated in cold weather and/or high altitude environments, such as in manned and unmanned (e.g. robotic/drone) aircraft etc.

According to the present invention there is provided a fuel heating apparatus for a spark-ignition engine of a type having a pressurised fuel delivery system, the apparatus comprising:
a chamber for receiving a volume of a pressurised liquid fuel; and
means for heating the fuel within the chamber to provide heated liquid fuel to the fuel delivery system of the engine, to thereby minimise condensation of the fuel and facilitate ignition of the engine within relatively low ambient temperature environments.

The apparatus of the present invention is preferably implemented within an engine of a spark-ignition type having a pressurised fuel delivery system. By ‘pressurised fuel delivery system’ we mean a conventional EFI (Electronic Fuel Injection) or Carburettor (air-aspirated) closed loop pressurised fuel circuit. However, it is to be appreciated that the present apparatus could be implemented in other engine types, including partially air-aspirated engines and compression-ignition engines etc., irrespective of the particular application (e.g. automotive, marine, aviation or power generation).

The provision of a chamber for receiving a volume of a pressurised liquid fuel enables a fixed volume of fuel to be heated as it propagates through the fuel delivery system of the engine. In this way, the chamber size may be selected to allow an optimised heating model to be implemented, so that the amount of energy required to heat the fuel may be functionally related to the volume of the fuel (hence chamber) and the rate at which the fuel passes through the chamber. By optimising the heating model in this way, the heating efficiency of the apparatus can be increased and therefore may be adapted to suit the particular engine type or fuel being used.

Hence, the dimensions (e.g. internal volume) of the chamber may be customised for the engine in which the apparatus is to be implemented. As a result, the present apparatus is advantageously scalable, as it may be incorporated within both small, mid-sized and relatively large engines without sacrificing any of the benefits of the invention.

Successively heating a fixed amount of fuel in a dedicated chamber of known size is advantageous over conventional fuel tank heating arrangements, as the energy requirements for heating are already known and therefore may be optimised to ensure efficient heating. Whereas pre-heating fuel in a fuel tank is generally inefficient, as the volume of fuel is not usually known a priori and therefore the heating cannot be optimised. Moreover, as the fuel tank is generally located remotely from the point of fuel delivery, heat losses from the fuel as it travels through the fuel delivery circuit can be significant. In this way, energy is therefore typically wasted and engine reliability cannot usually be guaranteed.

The present apparatus is preferably intended for use with heavy fuels, such as diesel or kerosene. However, it is to be appreciated that any other suitable fuel type may be used in conjunction with the apparatus of the present invention.

The chamber is preferably adapted to withstand the typical fuel pressures experienced within conventional pressurised fuel systems. Preferably, the chamber can therefore withstand fuel pressures within a range of about 10 kPa to up to about 350 kPa. It is to be noted that a typical EFI fuel pressure is around 300 kPa, while the fuel pressure within a conventional carburettor-based engine is around 14 kPa to 50 kPa. However, it is to be understood that the chamber may be adapted to withstand any desired fuel pressure depending on the particular application and engine that is used.

In preferred embodiments, the chamber is substantially cylindrical in form having a hollow interior (i.e. internal volume) to receive the pressurised liquid fuel. The chamber may be fabricated from any suitable material that is able to tolerate the temperatures and pressures found within spark-ignition engines. Preferably, the material may be thermally insulating so that no, or little, heat is lost from the external surface of the chamber to the surrounding engine environment. In this way, the heating efficiency may be further improved.

Preferably, the chamber includes both a fuel inlet and a fuel outlet that enables the chamber to be coupled inline with the fuel delivery system of the engine. In this way, pressurised fuel is forced to pass through the internal volume of the chamber, enabling the fuel to be heated before continuing on through the fuel delivery circuit.

In exemplary embodiments, the chamber is adapted to be disposed proximate to a point of fuel delivery, for example a fuel injector head, to minimise heat loss from the heated fuel to the surrounding components of the engine. In this way, fuel condensation can be avoided, or else minimised, as the fuel passes through the fuel delivery circuit. Placing the chamber as close as possible to a point of fuel delivery consequently lowers the energy demands required to heat the fuel, as less heat is lost to the engine environment, which thereby allows a lower volume (and hence smaller chamber size) to be used, as a larger body of heated fuel is not required as energy losses are minimised.

It is be appreciated however, that in other embodiments the chamber may be disposed in other locations, that are close to or spatially separated from a point of fuel delivery, but which still avoid or minimise fuel condensation and improve engine reliability. For example, the chamber may be incorporated within the throttle body of an EFI type engine, or be disposed within the body of a carburettor or carburettor fuel reservoir (e.g. float bowl), or alternatively in a fuel supply line.

In other preferred embodiments, the chamber may alternatively be incorporated into the fuel manifold itself, as an integral component thereof. Therefore, the manifold may be fabricated to include an apparatus according to the present invention, to thereby effect heating of the fuel as it passes through one or more fuel distribution channels within the fuel manifold.

The means for heating the fuel within the chamber are preferably disposed within the internal volume of the chamber. In exemplary embodiments, the heating means are electrical in nature and preferably comprise at least one electrically resistive heating element. The heating element is preferably in the form of a substantially flat disc, ideally metal or ceramic, being dimensioned to fit within the hollow cylindrical chamber. A heating circuit is printed on the disc, which comprises an embedded wire that exhibits ohmic heating when carrying a current. By ‘embedded’ we mean that the wire may reside partially on the surface of the disc or may alternatively be totally embedded within the disc.

The chamber may include one disc, or more preferably, a plurality of discs held in spaced relation in a vertical stack arrangement. The use of a vertical stack arrangement permits the fuel to flow between, and across the surfaces of, the individual discs to thereby increase the overall surface area to which the fuel is exposed. In this way, the heating of the fuel is found to be much more efficient and rapid, which avoids wasting energy and permits a smaller volume of fuel to be used to facilitate engine ignition. Since the volume of fuel can be reduced, the chamber can consequently be made smaller, which thereby minimises any modifications to the engine that may be necessary to implement the present apparatus.

To further improve the efficiency of the heating, each disc may include one or more fenestrations to allow the fuel to circulate around the discs and flow through and therebetween.

It is to be appreciated however that the heating element of the present invention may adopt any suitable geometric shape or form depending on the particular application and implementation. Therefore, although a disc shaped element is most preferred, the element may be elliptical, square, rectangular or hexagonal etc. without sacrificing any of the benefits of the present invention.

The heating means preferably heats heavy fuels to a temperature within the range of about 100 degrees C. to about 140 degrees C., and most preferably to a temperature of about 120 degrees C. This temperature range is suitable to provide sufficient heat energy to the fuel to thereby assist the latent heat of vaporisation of the fuel to avoid, or minimise, fuel condensation. Moreover, the heating of the fuel may also lead to at least a partial vaporisation of the more volatile (e.g. lighter) components of the fuel, which may further facilitate ignition of the engine within low ambient temperature environments.

For lighter fuels, such as petrol (gasoline), the temperature range need not be so high and therefore the heating means preferably heats light fuels to about 30 degrees C. in order to facilitate engine ignition and run-on. Of course, the temperature range that is adopted will depend on the particular heating model that is implemented, which in turn will be related to the type of fuel and engine that are being used.

Any suitable heating model may be implemented to heat the fuel depending on the particular application. Therefore, by altering the number of heating discs or by selectively powering some or all of the discs within the chamber, different heating models can be put into effect. Thus, the apparatus can be adapted for different arrangements and different fuel types by simply varying the number of heating discs that are provided with power and/or by increasing/decreasing the current to the discs. Furthermore, the current to the discs may also be pulsed, so that heating is provided in intermittent bursts, to thereby reduce the total amount of energy required to heat the fuel.

Although the preferred embodiments make use of a stacked arrangement of discs for heating the fuel, it is to be appreciated that any other suitable form of heating means may be used in conjunction with the apparatus of the present invention. In particular, in other embodiments, a high power density ceramic heater may alternatively be used which has been found to effect rapid heating of the fuel within the chamber.

It is to be understood that the fuel heating apparatus of the present invention can be implemented as a single unit or as multiple units within any particular engine. Therefore, depending on the particular application, engine type and fuel used, there can be one or more chambers installed within the fuel delivery system of the engine. Moreover, a particular engine may include any number of different embodiments of the apparatus. Hence, for example, one chamber may be incorporated into the throttle body of the engine, while several others may be disposed within a respective fuel supply line of the fuel delivery circuit.

The degree of fuel heating required will obviously depend on the type of engine used and the environment in which the engine ignition is to be effected. Hence, in cold weather, different heating models may be implemented in accordance with the type of heating means that is fitted within the chamber. However, in all applications it is found that the heating of the fuel in accordance with the present apparatus, avoids or minimises fuel condensation, while also improving fuel atomisation and fuel-air mixing, to thereby increase engine efficiency and reliability in cold weather use.

Due to the form and arrangement of the fuel heating chamber, and the fact that it is preferably implemented within a pressurised fuel delivery system, it has been found that the present apparatus may be used in applications where the engine may be subjected to operation in different orientations. In other words, the present apparatus is independent of orientation of the engine and therefore may be used reliably in aviation applications where the engine may be inverted, and/or laterally rotated during periods of use.

Consistent with each of the embodiments of the present invention, the apparatus further includes a controller coupled to the heating means to control the heating of the fuel by implementing any suitable heating model. Preferably, the controller is electrically connected to the one or more heating discs in the chamber and can provide current to the disc(s) to effect heating of the fuel. The controller preferably comprises an interface for interfacing with the ECU (Engine Control Unit) of the engine.

By ‘ECU’ we mean the conventional processor or control circuit that performs engine management and conditioning. Most modern engines make use of an ECU device to manage the critical systems (e.g. fuel delivery and timing etc.) of the engine. The ECU may alternatively be referred to as the ‘Engine Conditioning Unit’ or ‘Engine Management Unit’ in the prior art. Herein, references to ‘ECU’ are intended to include all known types of engine management controllers.

The controller is preferably mounted within a separate module or enclosure, located remotely from the chamber. In preferred arrangements, the controller is adapted to be switched via the ECU. The controller is preferably pre-programmed to implement any suitable heating model in accordance with the particular application and engine being used. In preferred arrangements, the controller also comprises thermostatic control means that are able to precisely control the temperature of the fuel and are operable to prevent any over-heating events that could potentially damage the heating elements.

In other arrangements, the controller may be manually activated by an operator who initiates heating of the fuel as a precursory step prior to engine ignition.

The present invention may be modified to further improve the efficiency and reliability of the engine within low ambient temperature environments. Therefore, consistent with any of the preceding embodiments, the present apparatus may additionally comprise a complementary air heating means to reduce, or minimise, fuel condensation further and to effect a better fuel-air mixture prior to combustion in the engine.

Preferably, the air heating means comprises an electrical heating element installed proximate to an air intake component of the engine, e.g. air filter or carburettor etc. In this way, air that is drawn into the engine may be pre-heated prior to mixing with the heated fuel, which thereby warms the engine and further mitigates against heat losses from the fuel as is passes through the fuel delivery system.

The air heating means is preferably a relatively compact device that may be fitted within an air intake duct or conduit of the engine. Due to the complementary action of the air heating means, a smaller volume of fuel need only be heated, thereby further lowering heating energy demands and enabling the chamber to be consequently reduced in size. In preferred embodiments, the air heating means is controlled via the engine's ECU, so that complementary heating of the fuel and the air may be precisely monitored and managed.

Although the present invention is ideally suited for facilitating ignition (or start-up) of spark-ignition engines using heavy fuels within relatively low ambient temperature environments, it will be recognised that one or more of the principles of the invention could also be used in other engine or fuel delivery applications where it is desired to mitigate against the effects of fuel condensation and to improve engine efficiency and reliability.

Embodiments of the invention will now be described in detail by way of example and with reference to the accompanying drawings in which:

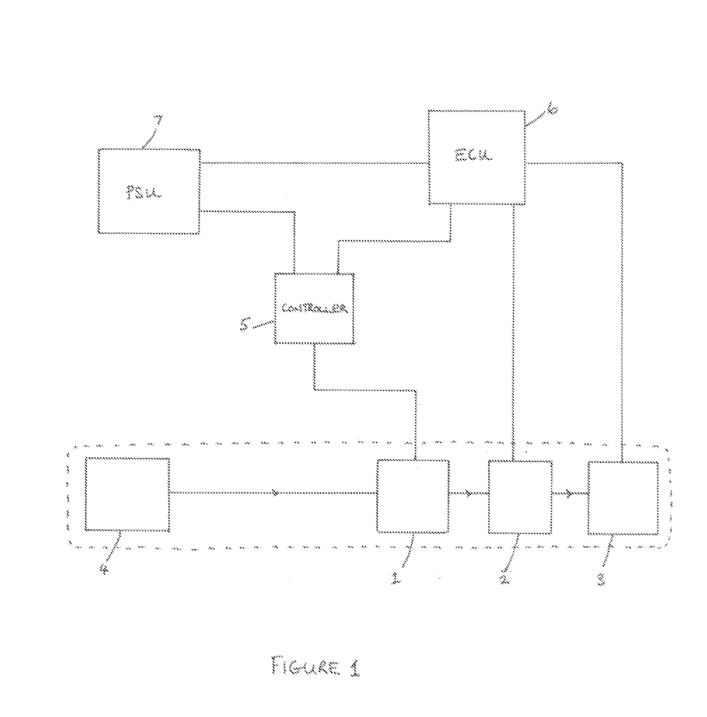

FIG. 1 is a schematic representation of a preferred implementation of a fuel heating apparatus according to the present invention.

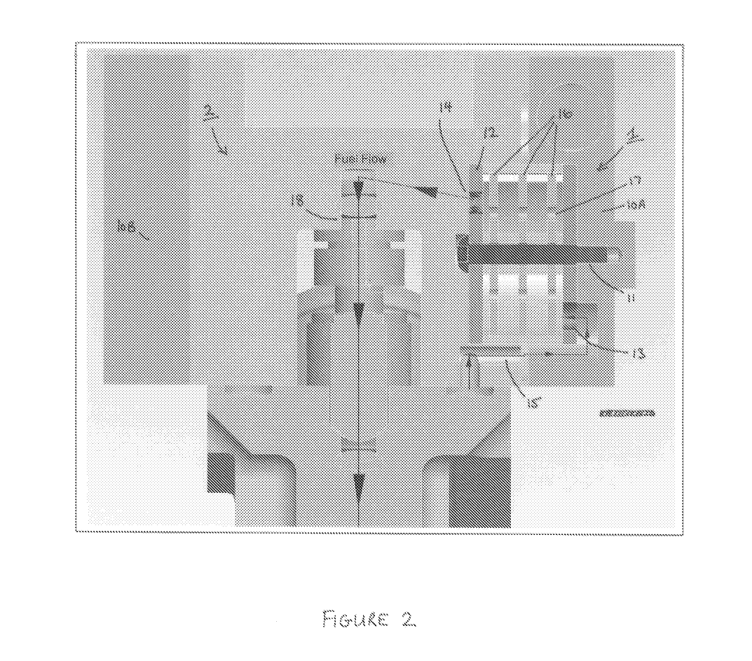

FIG. 2 is a side cross-sectional view of an exemplary embodiment of the fuel heating apparatus implemented within a fuel injector assembly.

Referring to FIG. 1, there is shown an example implementation of a fuel heating apparatus according to the present invention. The apparatus has been fitted within an EFI (i.e. a pressurised fuel injection) engine so that the chamber and heating means, represented by 1, are disposed within the fuel delivery circuit of the engine (shown as ghost lines).

The fuel delivery circuit comprises a fuel injector assembly 2, a combustion chamber 3 and a fuel tank or fuel reservoir 4. The chamber and heating means 1 are coupled inline with the fuel supply line from the fuel tank 4 and the injector assembly 2. The liquid fuel within the fuel tank 4 is at the approximate temperature of the ambient surroundings, and therefore in cold weather environments it is to be assumed that the fuel is at a low temperature.

To improve heating efficiency and lower the energy requirements for heating the fuel, the chamber and heating means 1 are located as close as possible to the injector assembly 2. In this way, a smaller volume of fuel need only be heated within the chamber to effect engine ignition, as heat loss from the fuel to the engine environment is minimised since the fuel has a shorter distance to travel before entering the injector assembly 2. Moreover, as the chamber and injector assembly 2 are located proximate to each other, the likelihood of fuel condensation occurring is also significantly reduced, as there is less opportunity for the fuel to loose heat before it enters the injector assembly 2.

The chamber and heating means 1 receive pressurised fuel via a fuel supply line connected to the fuel tank 4, which then enters the chamber and is heated by the heating means within the chamber. The heating of the fuel is controlled by a controller 5 that is electrically coupled to the heating means. The controller 5 is mounted within a separate enclosure, preferably located remotely from the chamber, and is ideally fixed within the engine bay close to the ECU (Engine Control Unit) 6. Alternatively, the controller may be adapted to form an integral component of the chamber itself, or else be attached thereto, so that the apparatus may be in the form of a self-contained module.

The controller 5 and ECU 6 are electrically connected so that the ECU 6 can activate/deactivate heating of the fuel in accordance with a prescribed engine management algorithm etc. Since the present invention is intended, in part, to facilitate engine ignition, the ECU 6 can be programmed to automatically initiate fuel heating as part of the engine start-up procedure.

The controller 5 can implement any of a number of different heating models, depending on the particular heating requirements and/or engine type, and is controlled via a switchable 5 Vdc supply provided by the ECU 6. A thermostatic control circuit (not shown) within the controller 5 precisely controls the temperature of the fuel (in accordance with the particular heating model) and is operable to prevent over-heating events to avoid damaging the heating means. The thermostatic control circuit is able to control the temperature of the fuel to a predetermined temperature set-point to an accuracy of +/−10 degrees C.

The controller 5 is powered via the engine's internal power supply 7, which in typical automotive applications is the vehicle's 12 Vdc battery or alternator, while in aviation applications (e.g. light aircraft or unmanned drones etc.) is usually a 28 Vdc battery. In most applications, this power supply also provides power to the engine's ECU 6.

Alternatively, power for the heating means may be supplied from an external power source, such as rectified mains electricity, a battery arrangement or a portable generator etc. In this way, engine ignition can be facilitated without placing an additional burden on the engine's own power supply.

The heating means within the chamber are provided with electrical power via the controller 5, which can increase/decrease the amount of current supplied to the heating means in accordance with the particular heating requirements.

Referring to FIG. 2, there is shown an exemplary example of a fuel heating apparatus according to the present invention. The chamber and heating means 1 are installed within the head of the injector assembly 2. The chamber is dimensioned so as to be fixed to one of the sides of the injector head via a threaded bolt 11 that passes through the axis of the chamber and into the wall 10A of the injector head.

As shown in FIG. 2, the chamber comprises a body 12 that is cylindrical in form and which defines an internal volume to receive fuel from the fuel delivery circuit. The chamber body 12 includes both a fuel inlet 13 and a fuel outlet 14 coupled inline with the direction of fuel flow (indicated by the solid arrow). The fuel inlet 13 is connected to a fuel distribution channel 15 in the injector head, which in turn receives fuel from the fuel tank 4 at ambient temperature. The chamber body 12 includes a heating means in the form of a vertical stack of heating discs 16, which in the example of FIG. 2, corresponds to a stack of 3 discs. By ‘vertical’ we mean that the discs are stacked one on top of the other in spaced relation, such that the planes of the discs are orthogonal to the axis of the chamber.

A heating circuit is printed on each of the discs 16, comprising a wire that when carrying a current heats the disc via an ohmic heating process. In the example of FIG. 2, the wire is printed in a coiled spiral configuration (not shown), so that the wire extends diametrically across the disc. The controller 5 provides current to the discs 16 according to the particular heating model, so as to heat the fuel within the chamber body 12.

The controller 5 can vary the current to the discs and/or selectively cause heating of one or more of the discs to precisely control the heating of the fuel. In applications where the fuel is a heavy fuel, such as diesel or kerosene, the heating model can be adapted to the particular type of fuel so that the temperature of the fuel can be accurately and reliably controlled.

The use of a vertical stack of spaced discs 16 is found to be particularly advantageous, as the fuel is able to flow between the discs 16 and consequently is exposed to a greater surface area for heating of the fuel. In this way, the energy requirements, together with the time taken to heat the fuel, are reduced, thereby increasing the efficiency of the heating process.

To further enhance the efficiency of the heating process, the discs 16 can be fenestrated to allow the fuel to flow through the discs 16, as shown by the apertures 17 in FIG. 2. Where the discs 16 are sized so as to extend substantially across the diametrical width of the chamber body 12, the apertures 17 serve as fuel flow paths permitting the heated fuel to egress from the internal volume of the chamber.

The heated fuel egresses from the fuel outlet 14 due to the pressure within the fuel delivery system of the engine and proceeds to enter the injector 18, as shown by the solid arrow, for combustion within the combustion chamber 3.

It is to be appreciated that although FIGS. 1 and 2 have been described in relation to only a single chamber and heating means, any particular engine may include any number of fuel heating apparatuses according to the present invention. Therefore, in accordance with the example of FIG. 2, a chamber body 12 may be disposed within each injector head of the engine to heat the fuel prior to injection into the combustion chamber.

The above embodiments are described by way of example only. Many variations are possible without departing from the invention.

1. A fuel heating apparatus for a spark-ignition engine of a type having a pressurised fuel delivery system, the apparatus comprising:
a chamber for receiving a volume of a pressurised liquid fuel; and
a plurality of electrically resistive heating elements disposed within the chamber to provide heated liquid fuel to the fuel delivery system of the engine, to thereby minimise condensation of the fuel and facilitate ignition of the engine within relatively low ambient temperature environments, each heating element being in the form of a substantially flat disc comprising an embedded wire, wherein the discs are held in spaced relation to facilitate the heating of the fuel therebetween.

2. The fuel-heating apparatus as claimed in claim 1, wherein the chamber is adapted to be disposed proximate to a point of fuel delivery.

3-5. (canceled)

6. The fuel-heating apparatus as claimed in claim 1, wherein the disc is fenestrated to allow fuel to flow therethrough.

7. (canceled)

8. The fuel-heating apparatus as claimed in claim 1, wherein the heating elements are adapted to heat heavy fuels to a temperature within a range of about 100° C. to about 140° C.

9. The fuel-heating apparatus as claimed in claim 1, wherein the chamber includes a fuel inlet and a fuel outlet for coupling inline with the fuel delivery system.

10. The fuel-heating apparatus as claimed in claim 1, wherein the chamber is adapted to be operably independent of orientation.

11. The fuel-heating apparatus as claimed in claim 1, wherein the chamber is adapted to withstand fuel pressure within the range of about 10 kPa to about 350 kPa.

12. The fuel-heating apparatus as claimed in claim 1, further comprising a controller coupled to the heating elements for operably controlling the temperature of the fuel.

13. The fuel-heating apparatus as claimed in claim 12, wherein the engine includes an engine control unit (ECU), and the controller comprises an interface that interfaces with the ECU.

14. The fuel-heating apparatus as claimed in claim 1, further comprising means for heating air derived from an air intake component of the engine to thereby provide heated air for mixing with the heated fuel.

14. The fuel-heating apparatus as claimed in claim 14, wherein the air heating means is electrical.

16. The fuel-heating apparatus as claimed in claim 1, wherein the fuel delivery system has at least one fuel injector and the chamber is disposed proximate to and upstream of the at least one fuel injector.

17. The fuel-heating apparatus as claimed in claim 1, wherein the fuel is selected from the group of fuels comprising: petrol, paraffin, kerosene and diesel.

18. A fuel manifold for a spark-ignition engine having a pressurised fuel delivery system, the manifold comprising:
at least one fuel inlet;
one or more fuel distribution channels connected to the at least one fuel inlet;
at least one fuel heating apparatus coupled to one or more of the fuel distribution channels, the fuel heating apparatus comprising a chamber for receiving a volume of a pressurised liquid fuel and a plurality of electrically resistive heating elements disposed within the chamber to provide heated liquid fuel to the fuel delivery system of the engine, to thereby minimise condensation of the fuel and facilitate ignition of the engine within relatively low ambient temperature environments, each heating element being in the form of a substantially flat disc comprising an embedded wire, wherein the discs are held in spaced relation to facilitate the heating of the fuel therebetween; and
at least one outlet for providing the heated fuel to the fuel delivery system of the engine.

19. A spark-ignition engine of a type having a pressurised fuel delivery system, the engine comprising:
at least one fuel heating apparatus comprising a chamber for receiving a volume of a pressurised liquid fuel and a plurality of electrically resistive heating elements disposed within the chamber to provide heated liquid fuel to the fuel delivery system of the engine, to thereby minimise condensation of the fuel and facilitate ignition of the engine within relatively low ambient temperature environments, each heating element being in the form of a substantially flat disc comprising an embedded wire, wherein the discs are held in spaced relation to facilitate the heating of the fuel therebetween.

20. (canceled)
